(19) United States
(12) Patent Application Publication
(10) Pub. No.: US 2025/0126226 A1
(43) Pub. Date: Apr. 17, 2025

(54) AUTOMATIC IDENTIFICATION OF CONTENT SHARED DURING VIDEOCONFERENCES

(71) Applicant: Highspot, Inc., Seattle, WA (US)

(72) Inventors: Lowell Geoffrey Vaughn, Bellevue, WA (US); Steven Edward Lucco, Bellevue, WA (US); Ming Ma, Bellevue, WA (US); Bryan Pirtle, Reno, NV (US); Ryan Buchmayer, Seattle, WA (US)

(21) Appl. No.: 18/917,779

(22) Filed: Oct. 16, 2024

Related U.S. Application Data
(60) Provisional application No. 63/590,696, filed on Oct. 16, 2023.

(51) Int. Cl. H04N 7/15; G06F 3/14; G06V 10/25; G06V 10/74; G06V 10/764

(52) U.S. Cl. CPC H04N 7/155; G06F 3/1454; G06V 10/25; G06V 10/761; G06V 10/764

(57) ABSTRACT

A content management platform automatically identifies content items that are presented during videoconferences. The platform is configured to access a video file that contains a plurality of frames of a recording of a videoconference, where the recording of the videoconference contains a record of screen sharing by one or more participants in the videoconference. The platform can classify one or more of the frames as content-containing frames. For each of these content-containing frames, the platform generates a vector representation of an image of at least a portion of the respective frame. An image of a respective frame can then be matched to a selected content item from a content repository, based on a degree of similarity between the image of the frame and the content item. The platform can then store a representation that links the video file to the selected content item.

### CROSS-REFERENCE TO RELATED APPLICATION

This application claims the benefit of U.S. Provisional Patent Application No. 63/590,696, filed Oct. 16, 2024, which is incorporated herein by reference in its entirety.

### BACKGROUND

Videoconferencing has become an integral part of modern communication. Many videoconferencing platforms enable content sharing during a videoconference, allowing a presenter to share content accessed from his or her device with other videoconference participants.

### BRIEF DESCRIPTION OF THE DRAWINGS

Detailed descriptions of implementations of the present invention will be described and explained through the use of the accompanying drawings.

FIG. 1 is a block diagram illustrating components of a content management platform, according to some implementations.

FIG. 2 illustrates a video processing flow, according to some implementations.

FIG. 3 is a flowchart illustrating a process for matching the content pages identified in a videoconference to specific content items, according to some implementations.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Videoconferencing has become integral to workplace and educational environments, enabling real-time audiovisual communication across geographic areas. During many videoconferences, users will share content with other users by displaying the content within the shared videoconference window. For example, a user may present slides in a slide deck while giving a presentation to the other videoconference participants, or may share a document on which the videoconference participants are collaborating. After the meeting has ended, it can be useful to link the content item to the videoconference. For example, some users may desire to review the content item at a later time to edit the item based on the meeting or to review the information discussed in the meeting. Linking the content item to the videoconference also enables an organization to track how its content items are being used, determine whether certain content items are presented to certain users, or maintain statistics that correlate use of a content item in a meeting to outcomes of the meeting. However, unless the user who presents a content item during a meeting explicitly links the content item to the video recording, it is tedious, error-prone, and computationally expensive to identify the particular content item that is presented. To solve these problems, a content management platform according to implementations herein performs processes to automate the identification of content items from videoconference recordings.

In some implementations, a content management platform accesses a video file that contains a plurality of frames of a recording of a videoconference, where the recording of the videoconference contains a record of screen sharing by one or more participants in the videoconference. The platform can classify one or more of the frames as content-containing frames. For each of these content-containing frames, the platform generates a vector representation of an image of at least a portion of the respective frame. An image of a respective frame can then be matched to a selected content item from a content repository, based on a degree of similarity between the image of the frame and the content item. The platform can then store a representation that links the video file to the selected content item. Using this representation, the platform can make the selected content item available to users who attended the videoconference or users who are later accessing a recording of the videoconference. For example, the platform may automatically send the content item to any attendees of a videoconference.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

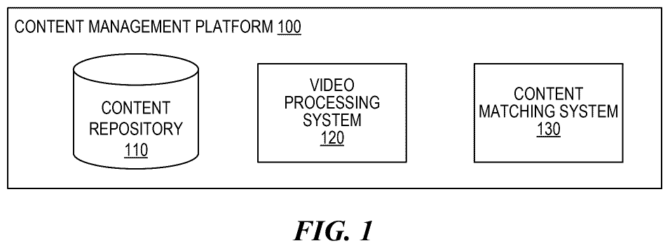

FIG. 1 is a block diagram illustrating components of a content management platform 100, according to some implementations. As shown in FIG. 1, the content management platform 100 can include a content repository 110, a video processing system 120, and a content matching system 130.

The content repository 110 stores content items such as documents, videos, images, or audio recordings. Documents stored in the content repository 110 can include, for example, slide decks, technical reports, sales brochures, books, web pages, transcriptions of video or audio recordings, or any other type of document. In some implementations, the content management system enables users to add content items in the content repository to a person collection of items. These collections, referred to herein as “spots,” can include links to content items in the content repository 110, copies of items in the content repository, and/or external content items (or links to external content items) that are not stored in the content repository. Users can create spots for their own purposes (e.g., to keep track of important documents), for organizing documents around a particular topic (e.g., to maintain a set of documents that are shared whenever a new client is onboarded), for sharing a set of documents with other users, or for other purposes. In some cases, users may be able to access the spot created by other users.

In some implementations, the content management platform 100 facilitates access to the content items in the content repository 110 via an application or a web portal, which are accessed by the user devices to enable users to create content items, view content items, share content items, or search content items. The content management platform 100 can include enterprise software that manages access to a company's private data repositories and controls access rights with respect to content items in the repositories. However, the content management platform 100 can include any system or combination of systems that can access a repository of content items, whether that repository stores private files of a user (e.g., maintained on an individual's hard drive or in a private cloud account), private files of a company or organization (e.g., maintained on an enterprise's cloud storage), public files (e.g., a content repository for a social media site, or any content publicly available on the Internet), or a combination of public and private data repositories.

The content management platform 100 can maintain interaction data quantifying how users interact with the content items in the content repository 110. Interaction data for a content item can include, for example, a number of users who have viewed the item and time stamps for each viewing, user dwell time within the item (represented as dwell time in the content item overall and/or as dwell time on specific pages or within particular sections of the content item), number of times the item has been shared with internal or external users, number of times the item has be presented during videoconferences, number of times the item has been bookmarked by a user or added to a user's collection of documents (a “spot”), number of times an item has been edited, type and nature of edits, etc. When the content repository stores files of a company or organization, the interaction data can be differentiated according to how users inside the company or organization interact with the content and how users outside the company or organization interact with it.

The video processing system 120 ingests video recordings of videoconferences conducted via a videoconferencing platform. The videoconferencing platform can be a platform that is integrated with or linked to the content management platform 100, supporting synchronous video or audio-based communication between user devices. Videoconferences can be recorded by the videoconferencing platform upon instruction by a participant, such that the video recordings are stored in a repository that is accessible to the video processing system 120. Alternatively, video recordings captured by any of a variety of third-party videoconferencing platforms, external to the content management platform 100, can be provided to the video processing system 120 for analysis. The video processing system 120 processes the ingested video to generate a representation of any content item shared on-screen during the recorded videoconference.

The content matching system 130 uses the representations output by the video processing system 120 to identify matches to content items in the content repository 110.

The content management platform 100 uses the video processing system 120 and the content matching system 130 to identify content shared during a videoconference. Generally, content item matches can be determined by generating a vector to represent images extracted from a videoconference recording. The platform 100 determines a similarity between these vectors and vectors of content items in the content repository 110. If a vector of an item in the content repository 110 has at least a threshold similarity to a vector representing an image extracted from a videoconference, the platform 100 can identify the content items as a match.

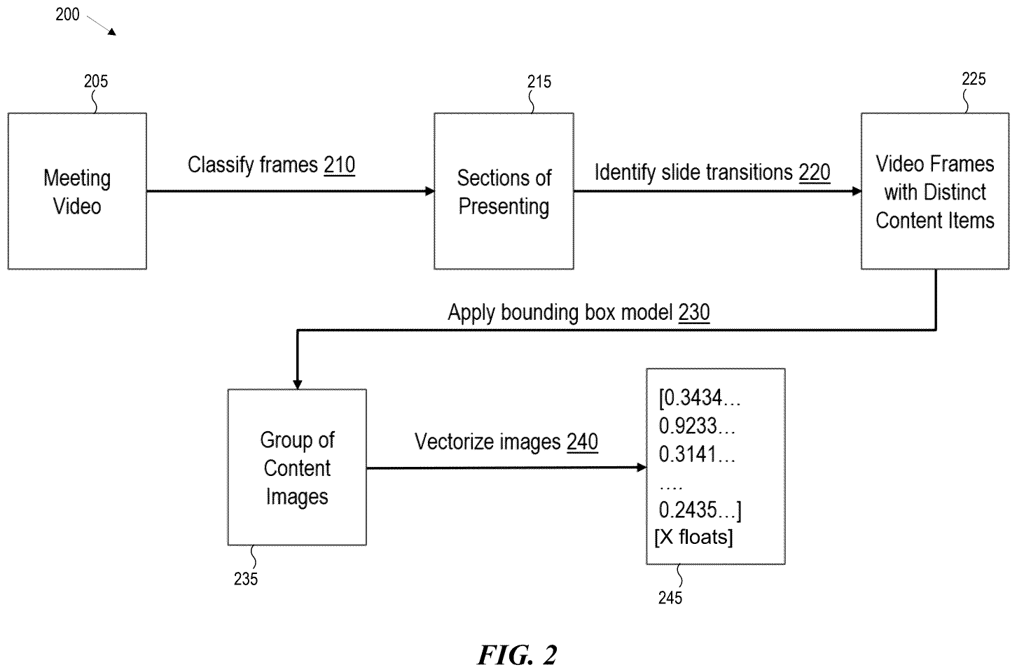

FIG. 2 illustrates a video processing flow 200, according to some implementations. The video processing flow can be performed by the video processing system 120. Other implementations include additional, fewer, or different steps, or perform the steps in different orders.

As shown in FIG. 2, the video processing system 120 receives a meeting recording 205, a file that contains a plurality of frames of a recording of a videoconference meeting. The meeting recording can be accessed from a repository of meeting recordings, which may be part of the content repository 110. For example, the video processing system 120 processes meeting recordings upon detecting that a new recording has been added to the repository or on a batch basis (e.g., once per day). Alternatively, a user can upload the meeting recording 205 to the video processing system 120 or can explicitly select the meeting recording from the repository for analysis by the system.

At 210, the video processing system 120 applies a classifier to classify frames from the meeting recording 205. The frame classifier, according to at least some implementations, is a deep learning model that is trained with labeled images to classify video frames into one of multiple candidate classifications. The frame classifier can classify frames based at least in part on an image of at least a portion of the frame, inputting features of the image to the model and outputting a classification of the frame based on the input features. In an example, the frame classifier is trained to classify video frames as either (i) a non-sharing frame or a non-content-containing frame (e.g., when only participants' videos are displayed, with no content sharing), or (ii) a content-containing frame (e.g., when a screen is being shared). Some implementations of the frame classifier are trained to generate multiple classifications of content-containing frames to distinguish between different types of content that may be shared on a screen. For example, the frame classifier can classify these content-containing frames as (i) a general-content frame (e.g., when a screen is being shared, but the screen does not contain a specific content item (such as if the screen being shared is a presenter's desktop, a blank document, or a webpage)), or (ii) a specific-content frame (e.g., where at least a portion of a document, video, slide deck, or other specific content item is shared on the screen). The frame classifier can be trained by supervised learning techniques in which training data includes frames from videoconference recordings that are assigned a certain category label. A representation of a frame from a videoconference recording can be provided to the model. Output from the model can be compared to the desired classification for that frame and, based on the comparison, the model can be modified, such as by changing weights between nodes of the neural network or parameters of the functions used at each node in the neural network (e.g., applying a loss function). After applying each of the labeled frames in the training data and modifying the model in this manner, the model can be trained to evaluate new videoconference frames to assign a corresponding classification to each frame.

Some implementations of the frame classifier can further use signals other than features of an image within the video frame to assign classifications, such as metadata associated with the videoconference, a transcript for the conference, or classifications of frames proximate to the frame of interest within the meeting recording. For example, a videoconferencing platform may add indicators within a transcript of a meeting or in metadata associated with the recording to indicate when screen sharing began or ended. In another example, the frame classifier processes text of the transcript to identify verbal cues that may suggest a user is sharing content or is not sharing content, such as “Let me share my screen,” “Can everyone see my screen?,” “next slide,” or the like.

The video processing system 120 can process a subset of the frames in the meeting recording 205 using the frame classifier. Because the same content item may be displayed on a presenter's screen for several seconds to several minutes, the video processing system 120 can increase the speed and efficiency of video processing by not applying the frame classifier to every frame in the video. For example, the video processing system 120 applies the frame classifier to a frame sampled from the video at periodic intervals, such as every 3-5 seconds. If the classification changes from a first sampled frame to a second, consecutively sampled frame, the video processing system 120 can perform a binary search of the frames between the first frame and the second to determine the frame at which the classification changed. Alternatively, the video processing system 120 can process a transcript or video metadata to detect a likely change in classification, for example to identify a signal indicating that a user likely started or stopped sharing content.

As an output of the frame classification process, the video processing system 120 can identify any sections 215 within the meeting recording in which content items are being shared. For example, the video processing system 120 outputs a list of timestamps or frame identifiers indicating when sharing of a specific content item started and ended throughout the duration of the meeting recording. The frames of the meeting recording that were not directly classified by the frame classifier can be assigned a classification based on the portion of the video in which they fall. For example, if Time A is recorded as the point when specific content sharing began and Time B recorded as the end of specific content sharing, each slide between Time A and Time B can be classified as a specific-content frame. In various implementations, and depending on the type of content that the content management platform 100 is seeking to identify in a videoconference, the set of sections 215 output by the video processing system 120 can represent the portions of the videoconference classified as specific-content frames, general-content frames, or both.

At 220, the portions of the meeting recording that were determined to contain specific-content sharing (e.g., all video frames classified as a specific-content frame) are passed to a slide transition identification procedure. In the slide transition identification procedure, the video processing system 120 identifies time stamps or frame identifiers at which transitions between content items occurred. For example, if the content being shared during a videoconference is a slide deck, the slide transition identification procedure determines when the presenter transitioned from one slide within the slide deck to the next. Similarly, the slide transition identification procedure can determine when a presenter moves to a next page in a document, switches from one content item (e.g., a first document) to another content item (e.g., a second document), or otherwise changes the content that is being shared during the videoconference. To detect these transitions, the video processing system 120 can perform an analysis of pixels in the frames classified as specific-content frames. Frames can be pre-processed to remove pixels that are unlikely to include the shared content, such as an outer portion of the frame and any portion of the frame in which participant videos are displayed. Using the pre-processed frames, the video processing system 120 can perform a frame-by-frame comparison of the pixels in each frame to detect when the shared content changes. For example, if at least 5% of the pixels in a pre-processed frame change from one frame of the meeting recording to the next, the video processing system 120 determines that the content has changed. Additionally or alternatively, the video processing system 120 can process verbal signals in the videoconference's transcript to detect signifiers that the content has changed or will change soon.

The output of the slide transition identification procedure 220 can be a set of video frames 225 that contain distinct content.

In some implementations, the video processing system 120 selects at least a subset of the general-content frames at 220, in addition to or instead of identifying transitions between content items within the frames labeled as specific-content frames. For example, the video processing system 120 captures a subset of the general-content frames from a videoconference. A subset of general-content frames can be sampled rather than identifying transitions between distinct content items within these frames, as described above for the specific-content frames. For example, a general-content frame may be more likely to include a video, a demonstration of a product, or another type of content presentation in which the pixels of the frames vary significantly from one frame to the next.

At 230, the video processing system 120 applies a bounding box model to the identified set of video frames 225. The bounding box model can take an array of pixels as input and produce, as output, four floating-point numbers that represent corners of a box. The bounding box model can be a convolutional neural network model that is trained to classify pixels in a video frame as “content” or “not content,” for example. As a result, the bounding box model can define a portion of each video frame in the set 225 that contains the shared content, cutting out pixels such as those containing thumbnails of the videoconference participants, window frames of the video itself or of the application in which content is being shared, or other portions of the video frame that are likely to be not specific to the shared content. The output of the bounding box application procedure 230 can be a group of content images 235, where each content image is a portion of a video frame. In some implementations, the video processing system 120 can further output an identification of an amount of time each content image was displayed during the videoconference, based on the number of frames of the video in which the content image appeared.

At 240, the video processing system 120 performs a vectorization process on each image in the set of content images 235 to produce a vector 245 uniquely representative of the content image. The vector 245 can be a certain size, depending on the inputs that are accepted by a large language model or another applicable system or model. For example, the vector can have a length of 512 float values, 1280 float values, or another applicable length. The video processing system 120 can employ any of a variety of vectorization algorithms or embedding models, such as img2vec, to produce a vector representation of each content image. In some implementations, the video processing system 120 filters the group of content images 235 prior to applying the vectorization algorithm. For example, the video processing system 120 removes any content image that was displayed within the recorded video for less than one second, based on a determination that the content was likely to have been displayed only incidentally (e.g., because the presenter skipped past a slide in a slide deck) or that the content likely included moving elements (e.g., in case a video or animation was shared during the videoconference).

Accordingly, by the end of the video processing flow 200, the video processing system 120 has produced a set of vectors that represent images of content items or portions of content items shared during a videoconference. The vectors can further be associated with information indicating the amount of time the corresponding content item was displayed during the videoconference, such as time stamps of the start and end points for a content item being shared.

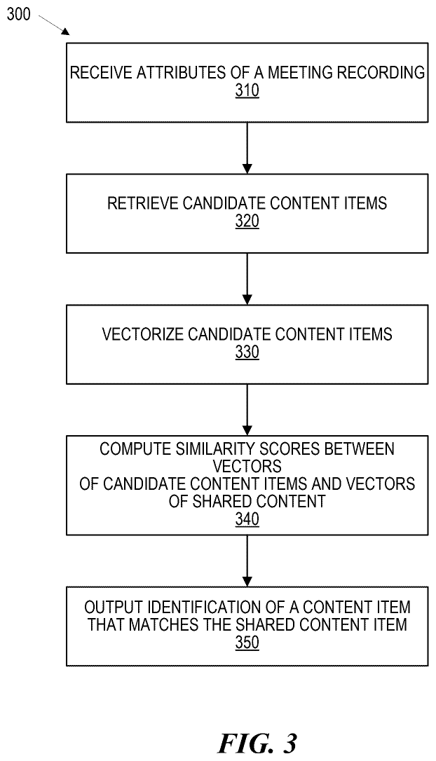

The vectors generated by the video processing flow 200 can be matched to content items in the content repository 110 to identify the items shared during a videoconference. FIG. 3 is a flowchart illustrating a process 300 for matching the content pages identified in a videoconference to specific content items in the content repository 110. The process 300 can be performed by the content matching system 130, in some implementations.

As shown in FIG. 3, the content matching system 130 receives, at 310, attributes of a meeting recording to which the content matching system 130 will match content. The attributes can include any metadata associated with the recording or knowledge graph data that can be used to help identify content shared during the meeting or to speed up a process of finding the shared content. For example, these attributes can include an identifier of a user who presented content during the videoconference and a date of the videoconference. Other example attributes received by the content matching system 130 can include a list of meeting attendees, a title of the meeting, or subjects discussed during the meeting, which can be used to identify a likely subject matter of any content that was shared during the meeting.

At 320, the content matching system 130 retrieves candidate content items from the content repository 110. Candidate content items can be selected based on a heuristic. For example, the content matching system 130 retrieves any content item that was accessed by the presenting user in the last 30 days, based on an expectation that the presenter likely created, edited, or reviewed the content item that was presented during the meeting in advance of the meeting. Alternatively, the content matching system 130 can retrieve a set of content items that the presenting user frequently shares during videoconferences or has historically shared during videoconferences with the same attendees as the conference under evaluation. The content matching system 130 may also retrieve only certain types of content items based on an expectation that some types of content are more likely to be shared in a videoconference than other types of content items. For example, the content matching system 130 may begin a content matching procedure by first retrieving only slide decks, only expanding a search to other types of content if no matching slide deck is found. In implementations where the content management platform 100 maintains private data for organizations or data to which access is controlled by access rights, the content items that are retrieved at step 320 can be content items to which the presenting user has appropriate permissions or access rights.

Some implementations of the content matching system 130 can be configured to determine whether a user has shared a particular content item (or a content item from a particular set) during videoconferences, instead of or in addition to generally identifying any content item shared during a conference. Accordingly, the set of candidate content items can include the particular content item or set of particular content items. For example, if a company is evaluating whether its salespeople are presenting a specified slide during sales pitches, the content matching system 130 determines a degree of similarity between the specified slide and content extracted from recordings of the sales pitches.

After identifying candidate content items, the content matching system 130 vectorizes the candidate content items at 330. The content matching system 130 can generate vectors to represent the candidate content items using the same vectorization algorithm as that used by the video processing system 120 to generate the vectors 245. For content items with multiple pages, such as a slide deck, the content matching system 130 can generate a vector for each page within the content.

For at least a subset of the vectors representing a shared content page, the content matching system 130 at 340 determines a similarity, such as a cosine similarity, between the shared content vector and a vector representing a candidate content item. Based on the similarity score, the content matching system 130 determines whether the shared content page matches one of the candidate content items. A match to a shared content item can be determined, for example, when a highest similarity score between the shared content item and a candidate content item is greater than a specified threshold. When a match is found between a shared content item and a candidate content item, the content matching system 130 can narrow the set of candidate content items that are compared to other shared content items from the same videoconference. For example, if the content matching system 130 finds a match to a first slide in a slide deck, the content matching system 130 can start by comparing the next content item extracted from the videoconference to other slides in the same slide deck before searching for a match among other candidate content items.

For some types of content items, some implementations of the content matching system 130 identify a match between the shared content item and a candidate content item based on matching multiple portions of the content items. For example, an organization may reuse slides across multiple slide decks. To identify the particular slide deck that is being presented during a given videoconference, the content management system 130 can use matches between multiple slides in the shared content item and multiple slides in the candidate slide decks to identify the slide deck with the best match to the shared content item.

If a match between a shared content item and a candidate content item is found, the content matching system 130 outputs an identifier of the match at 350. If no match is found to a shared content page, the content matching system 130 can either expand the set of candidate content items and repeat the matching process 300, or can output a determination that no match is available.

The content matching system 130 can store a representation that links the videoconference to the matching content item. This representation can include, for example, metadata associated with the videoconference file, the matching content item, or both, that identifies that videoconference has been matched to the matching content item. In another example, an actionable link can be added to the videoconference file or the content item within the content repository, where activation of the link navigates to the other item.

In some implementations, each content item in the content repository 110 is vectorized prior to the matching process 300. Accordingly, rather than selecting candidate content items or to more quickly search the candidate content items, the content matching system 130 can perform a vector search of a vector database associated with the content repository 110 to identify content items in the content repository 110 that are similar to the vector produced for the content item extracted from the videoconference.

Instead of or in addition to processing specific-content frames as described with respect to FIG. 3, some implementations of the content matching system 130 can process general-content frames to identify the content that is shared on the general-content frames. For some types of content, the content matching system 130 can extract text from the video recording frames to identify the content of a general-content frame. In an example, the content matching system 130 extracts a URL from a browser window displayed during the video. For other types of content, the content matching system 130 can perform similar analysis as is performed for specific-content frames. For example, a product demo can have an associated vector representing features of the product demo (e.g., representing visual elements that are likely to be displayed during the demo or words that the presenter is likely to speak during the demo). The general-content frames can be vectorized by a similar vectorization algorithm. The content matching system 130 can then determine a similarity between the vector of the general-content frames and the expected product demo vectors to determine whether it is likely that the general-content vectors include the product demo. Alternatively, the content matching system 130 can send a transcript of the presenter's speech coinciding with the general-content frames to a large language model, which in turn can analyze latent space embeddings of the speech to determine if the presenter was speaking about a particular topic (e.g., demoing a particular product).

Furthermore, some implementations of the video processing system 120 extract text from a frame, instead of or in addition to generating embeddings that represent images of frames. The system generates an embedding to represent the extracted text or a portion of the extracted text. Using this text embedding, the video processing system 120 searches a repository of content items to match the text from the frame to a similar portion of text within a content item. The set of content items that are searched can be initially narrowed in ways similar to those described above, such as the system 120 first searching the text within a set of content items that were recently accessed by the user who is presenting a content item during the videoconference.

The content management platform 100 can use the identification of content shared during videoconferences to generate any of a variety of metrics or outputs associated with the shared content items. For example, the platform 100 can use content matching processes described herein to achieve any of the following results:
The matched content can be automatically provided to attendees of the videoconference or linked to the recording of the videoconference for users who view the recording at a later time.
Additional engagement metadata or use data can be generated for content in the content repository 110 to indicates the number of times the content has been shared during videoconferences or the amount of time it was displayed on-screen during these meetings. As described above, the output of the video processing flow 200 can include both vectors of any content item shared during a videoconference, as well as time stamps or other temporal identifiers that indicate how long each content item was shared. By matching the shared content items to content in the repository 110, the content matching system 130 can generate the additional engagement metadata for the content items in the repository 110.
Statistics for the presenting user can be generated based on the content items that were shared during videoconferences and how long each item was shared. A salesperson can be evaluated, for example, based on an amount of time the salesperson discussed each slide in a pitch deck or based on whether the salesperson presented a particular demonstration of a product.
Content sharing statistics can be aggregated across multiple videoconferences within an organization and compared to certain organization-wide metrics to identify whether there is a causal effect between sharing of certain content items and certain metrics. For example, in a sales context, the amount of time a certain slide was presented during sales pitches can be compared against revenue to determine if the slide has an effect on sales. Similarly, in an educational context, a teacher of an online course can determine if the ratio between different types of content presented in a lecture have an effect on students' grades.

### Computer System

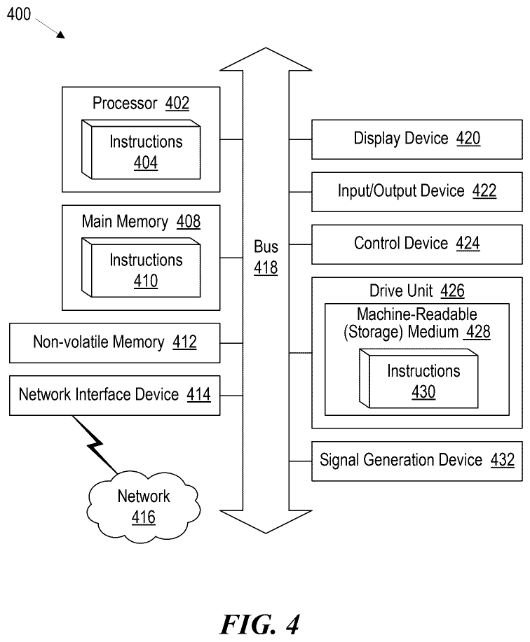

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, a video display device 418, an input/output device 420, a control device 422 (e.g., keyboard and pointing device), a drive unit 424 that includes a machine-readable (storage) medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementations, the computer system 400 can be an embedded computer system, a system-on-chip (SOC), a single-board computer system (SBC), or a distributed system such as a mesh of computer systems, or it can include one or more cloud components in one or more networks. Where appropriate, one or more computer systems 400 can perform operations in real time, in near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method comprising:
accessing a video file that contains a plurality of frames of a recording of a videoconference,
wherein the recording of the videoconference contains a record of screen sharing by one or more participants in the videoconference;
generating, for each respective frame in an identified set of frames, a vector representation of an image of at least a portion of the respective frame;
wherein the identified set of frames includes one or more frames of the recording of the videoconference that have been classified as content-containing frames;
matching an image of a respective frame in the identified set of frames to a selected content item from a content repository, based on a degree of similarity between (i) the vector representation of the image of the respective frame in the identified set of frames, and (ii) a vector representation of the selected content item; and
storing a representation linking the video file to the selected content item.

2. The method of claim 1, further comprising:
applying a classification model to at least a subset of the plurality of frames,
wherein the classification model is configured to input an image of each frame in the subset of frames and to output, for each frame in the subset of frames, one of a set of predefined classifications of the frame, and
wherein the set of predefined classifications of the frame includes a content-containing-frame classification.

3. The method of claim 2, further comprising:
selecting the subset of the plurality of frames by:
generating a subsample of the plurality of frames;
for a consecutively subsampled first frame and second frame of the plurality of frames, applying the classification model to each of the first frame and the second frame to generate a first classification of the first frame and a second classification of the second frame;
if the first classification is a content-containing-frame classification, adding the first frame to the subset of the plurality of frames; and
if the second classification is a content-containing-frame classification, adding the second frame to the subset of the plurality of frames.

4. The method of claim 3, wherein selecting the subset of the plurality of frames further comprises:
in response to determining the first classification and second classification are different, performing a binary search of frames between the first frame and the second frame in the video file to identify a third frame at which a classification transitioned from the first classification to the second classification; and
adding the third frame to the subset of the plurality of frames.

5. The method of claim 1, further comprising:
classifying at least a subset of the plurality of frames based on metadata associated with the subset;
wherein the identified set of frames comprise one or more frames that are classified as content-containing frames based on the metadata of the one or more frames.

6. The method of claim 1, further comprising:
processing the identified set of frames to identify a transition from a first content item to a second content item.

7. The method of claim 6, wherein processing the identified set of frames comprises:
detecting, for a first frame and a second frame of the identified set of frames, that at least a threshold quantity of pixels are different between the first frame and the second frame;
wherein the first frame or the second frame is identified as the transition from the first content item to the second content item.

8. The method of claim 1, further comprising:
applying, to a first frame of the identified set of frames that is classified as content-containing frame, a bounding box model;
wherein the bounding box model defines, for the first frame, a region of the frame that contains a content item;
extracting an image of the first frame that includes the defined region of the frame;
wherein the image of the first frame is matched to the selected content item from the content repository.

9. The method of claim 1, further comprising:
identifying, for the respective frame, an identity of a user who is sharing content during the respective frame; and
accessing a set of candidate content items from the content repository with which the identified user interacted during a specified time period preceding a time of the videoconference;
wherein matching the image of the respective frame to the selected content item from the content repository comprises:
generating a measure of similarity between (i) the vector representation of the image of the respective frame and (ii) vector representations of each of the set of candidate content items.

10. The method of claim 1, further comprising:
storing, for a plurality of content items in the content repository, use data that describes user interactions with each of the plurality of content items; and
updating the use data associated with the selected content item in response to matching the image of the respective frame to the selected content item.

11. The method of claim 1, further comprising:
identifying a set of attendees of the videoconference; and
sending the selected content item to the identified attendees in response to matching the image of the respective frame to the selected content item.

12. A content management system comprising:
one or more processors; and
one or more non-transitory computer readable media storing executable computer program instructions that, when executed by the one or more processors, cause the content management system to:
access a video file that contains a plurality of frames of a recording of a videoconference;
generate, for each respective frame in an identified set of frames, a vector representation of an image of at least a portion of the respective frame;
wherein the identified set of frames includes one or more frames of the recording of the videoconference that have been classified as content-containing frames;
match an image of a respective frame in the identified set of frames to a selected content item from a content repository, based on a degree of similarity between (i) the vector representation of the image of the respective frame in the identified set of frames, and (ii) a vector representation of the selected content item; and
store a representation linking the video file to the selected content item.

13. The content management system of claim 12, wherein execution of the instructions by the one or more processors further causes the content management system to:
apply a classification model to at least a subset of the plurality of frames,
wherein the classification model is configured to input an image of each frame in the subset of frames and to output, for each frame in the subset of frames, one of a set of predefined classifications of the frame, and
wherein the set of predefined classifications of the frame includes a content-containing-frame classification.

14. The content management system of claim 12, wherein execution of the instructions by the one or more processors further causes the content management system to:
process the identified set of frames to identify a transition from a first content item to a second content item, including:
detecting, for a first frame and a second frame of the identified set of frames, that at least a threshold quantity of pixels are different between the first frame and the second frame;
wherein the first frame or the second frame is identified as the transition from the first content item to the second content item.

15. The content management system of claim 12, wherein execution of the instructions by the one or more processors further causes the content management system to:
apply, to a first frame of the identified set of frames that is classified as content-containing frame, a bounding box model;
wherein the bounding box model defines, for the first frame, a region of the frame that contains a content item;
extract an image of the first frame that includes the defined region of the frame;
wherein the image of the first frame is matched to the selected content item from the content repository.

16. The content management system of claim 12, wherein execution of the instructions by the one or more processors further causes the content management system to:
identify a set of attendees of the videoconference; and
send the selected content item to the identified attendees in response to matching the image of the respective frame to the selected content item.

17. A non-transitory computer readable medium storing executable computer program instructions that, when executed by one or more processors of a system, cause the system to:
access a video file that contains a plurality of frames of a recording of a videoconference;
generate, for each respective frame in an identified set of frames, a vector representation of an image of at least a portion of the respective frame;
wherein the identified set of frames includes one or more frames of the recording of the videoconference that have been classified as content-containing frames;
match an image of a respective frame in the identified set of frames to a selected content item from a content repository, based on a degree of similarity between (i) the vector representation of the image of the respective frame in the identified set of frames, and (ii) a vector representation of the selected content item; and
store a representation linking the video file to the selected content item.

18. The non-transitory computer readable medium of claim 17, wherein execution of the instructions by the one or more processors further causes the system to:
apply a classification model to at least a subset of the plurality of frames,
wherein the classification model is configured to input an image of each frame in the subset of frames and to output, for each frame in the subset of frames, one of a set of predefined classifications of the frame, and
wherein the set of predefined classifications of the frame includes a content-containing-frame classification.

19. The non-transitory computer readable medium of claim 17, wherein execution of the instructions by the one or more processors further causes the system to:
process the identified set of frames to identify a transition from a first content item to a second content item, including:
detecting, for a first frame and a second frame of the identified set of frames, that at least a threshold quantity of pixels are different between the first frame and the second frame;
wherein the first frame or the second frame is identified as the transition from the first content item to the second content item.

20. The non-transitory computer readable medium of claim 17, wherein execution of the instructions by the one or more processors further causes the system to:
apply, to a first frame of the identified set of frames that is classified as content-containing frame, a bounding box model;
wherein the bounding box model defines, for the first frame, a region of the frame that contains a content item;
extract an image of the first frame that includes the defined region of the frame;
wherein the image of the first frame is matched to the selected content item from the content repository.
